(19) United States
(12) Patent Application Publication
(10) Pub. No.: US 2004/0235610 A1
(43) Pub. Date: Nov. 25, 2004

(54) Planet carrier for planetary gear set of automatic transmission

(76) Inventors: Seouk Kyoun Jang, Yongin-si (KR); Jong Kwan Park, Daegu (KR); Won Seog Koo, Daegu (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/751,024

(22) Filed: Dec. 31, 2003

(30) Foreign Application Priority Data
May 21, 2003 (KR) 2003-32299

(51) Int. Cl. F16H 57/08

(52) U.S. Cl. 475/331

(57) ABSTRACT

The present invention relates to a carrier of a planetary gear set of an automatic transmission. In a carrier of a planetary gear set of an automatic transmission that includes a boss part having a spline in an inner surface of the center, and a flange part coupled with the boss part and supporting a pinion, there is provided a carrier of a planetary gear set of an automatic transmission that is characterized in that the portions of the boss part except for a center portion in which the spline is formed are formed in a circular plate shape, and a plurality of bridges are formed on an upper surface of the flange portion at regular intervals, and a lower surface of the boss part is blazing-coupled with an upper surface of the bridge of the flange part, and a pinion installation space is formed between the neighboring bridges.

### CROSS-REFERENCE TO RELATED APPLICATIONS

This application claims priority of Korean Application No. 10-2003-0032299, filed on May 21, 2003, the disclosure of which is incorporated fully herein by reference.

### FIELD OF THE INVENTION

The present invention relates to a planet carrier for a planetary gear set of an automatic transmission, and in particular to an improved planet carrier for a planetary gear set of an automatic transmission in which a plurality of bridges blazing-coupled with a boss part are installed on an upper surface of a flange part at regular intervals wherein a boss part is formed in a circular plate shape unlike a conventional cup shape.

### BACKGROUND OF THE INVENTION

Generally, a power train of an automatic transmission includes a torque converter capable of transferring a driving force from an engine to a transmission, and a transmission mechanism capable of obtaining a proper rotational force. Here, the torque converter has a damper clutch and is adapted to decrease a loss of driving force by a sliding of the torque converter.

The transmission mechanism is adapted to change the speed of driving force transferred from an engine through the torque converter and to transfer to a driving shaft. The transmission mechanism is formed of a clutch of a two-set or three-set multiple-plate structure, a multiple-plate brake of one set, a band brake, a one-way clutch and a planetary gear set.

In the transmission, the clutch, brake, and one-way clutch are the elements capable of transferring or fixing a rotational force of the engine to the planetary gear set and each has a proper speed change ratio proper to an operation condition in accordance with an operation that a driving force is transferred to a certain element in the planetary gear set based on the above operation elements.

Therefore, in the operation of the transmission mechanism, the planetary gear set plays an important role for transferring the driving force. The planetary gear set generally includes a linear gear and ring gear, and a few number of planetary pinions supported by a rotating carrier on the same shaft as the above linear gear and ring gear. A few number of speed change combinations are implemented by fixing or driving the linear gear, ring gear and carrier.

Therefore, the planetary gear set is generally provided with the entire driving force and are always driven, so that the planetary gear set is known to determine the durability of the entire transmission system. In particular, the mechanical performance of the carrier coupled with the pinion having a higher rotation speed is known to affect the life span of the transmission.

According to the Japanese patent laid-open No. Hei 5-141483, a needle bearing is coupled between a pinion shaft to which a pinion is coupled, and a pinion. A washer extended in an axial direction of the pinion is provided in a lateral side of the pinion for thereby increasing an axial direction strength of the pinion. According to the Japanese patent laid-open No. Hei 10-288248, there are provided a boss part coupled with a shaft part, a plate part longitudinally extended in a radius direction, and a filler part extended in an axial direction with respect to the plate part and coupled with the base plate and having holes. Here, the filler part is thicker than the plate part for thereby enhancing the entire strength of the carrier.

In addition, according to the Japanese patent laid-open No. Hei 8-270789, the flange part and the plate part are coupled by an arm part. The arm part includes an upright part positioned in the same plane as the flange part, and a connection part having the same direction as the axial direction. The width of the connection part is wider than the width of the upright part for thereby increasing strength and processing property.

The carrier is constructed using a plurality of members as described above, and the adapted members are coupled by a certain coupling method such as a welding method, etc. for thereby fishing the structure.

Referring to FIGS. 1 through 3, the technical construction of one carrier finished using a plurality of the members will be described.

FIG. 1 is a perspective view illustrating a conventional carrier for a planetary gear set. FIG. 2 is a bottom perspective view illustrating a welding part in a conventional carrier of a planetary gear set. FIG. 3 is a cross sectional view taken along the line A-A of FIG. 1 for showing a cross section of the welding part.

A carrier 10 is a casing in which a pinion (not shown) is engaged. As shown in the drawings, the carrier 10 includes a cup-shaped boss part 12 having a spline 14 in an inner surface of the center, and a circular plate-shaped flange part 16 welded together with the boss part 12 and adapted to support the pinion.

In the construction of the carrier 10, the boss part 12 is formed in a shape that the lateral side is cut at regular intervals for thereby forming a pinion installation space. The flange part 16 is formed of a tooth shape 18 of a helical gear shape or spline shape in an outer surface of the same.

In particular, as shown in FIGS. 2 and 3, the end portion of the lateral surface of the boss part 12 is inserted into a welding hole 19 formed in the flange part 16 at regular intervals and is welded thereby. The carrier 10 is constructed in such a manner that the boss part 12 and the flange part 16 are integrally coupled.

As shown in FIG. 1, in order to fabricate the conventional carrier 10, the boss part 12 and the flange part 16 are separately fabricated based on a fine blanking method and a deep drawing method using a hot rolled steel sheet for a vehicle, and the above two elements are welded 20 using an electronic beam welding method (FIGS. 2 and 3), and then the spline 14 of the boss part and the helical gear 18 of the flange part 16 are processed.

However, in the conventional carrier, an expensive process such as a fine blanking process, deep drawing process, electronic beam welding process, etc. is performed due to a structural characteristic, and the number of processes, for example, spline process, etc., is increased, so that a fabrication cost is increased.

In addition, when the cup shaped boss part and the circular plate shaped flange part are beam-welded, a strain occurs due to a heat load, so that it is impossible to manage a tolerance between two elements. A friction by interference is increased during the operation of system.

### SUMMARY OF THE INVENTION

Embodiments of the present invention provide a carrier for a planetary gear set of an automatic transmission. In an exemplary embodiment, a boss part is formed in a circular plate shape unlike a conventional cup shape. A plurality of bridges are installed on an upper surface of the flange part at regular intervals. The bridges may be coupled with the boss part based on a blazing coupling method. It is possible to decrease a fabrication cost by removing an expensive process such as a deep drawing process adapted for a conventional cup shape formation and an electronic beam welding method for a coupling with the boss part and flange part when a sintering formation and blazing coupling are performed. It is possible to overcome a strain during a conventional electronic beam welding by improving a structure of a welding portion.

### BRIEF DESCRIPTION OF THE DRAWINGS

The aforementioned aspects and other features of the present invention will be explained in the following description, taken in conjunction with the accompanying drawings, wherein:

FIG. 1 is a perspective view illustrating a conventional carrier of a planetary gear set;

FIG. 2 is a bottom perspective view illustrating a conventional carrier of a planetary gear set;

FIG. 3 is a cross sectional view taken along the line 1-1 of FIG. 1;

FIG. 4 is a perspective view illustrating a carrier of a planetary gear set according to the present invention;

FIGS. 5A and 5B are disassembled perspective view illustrating a carrier of a planetary gear set according to the present invention;

FIG. 6 is a cross sectional view illustrating a blazing conjunction portion in a carrier of a planetary gear set according to the present invention; and

FIG. 7 is an engaging cross sectional view illustrating a fixing recess and a fixing protrusion taken along the line 2-2 of FIG. 4.

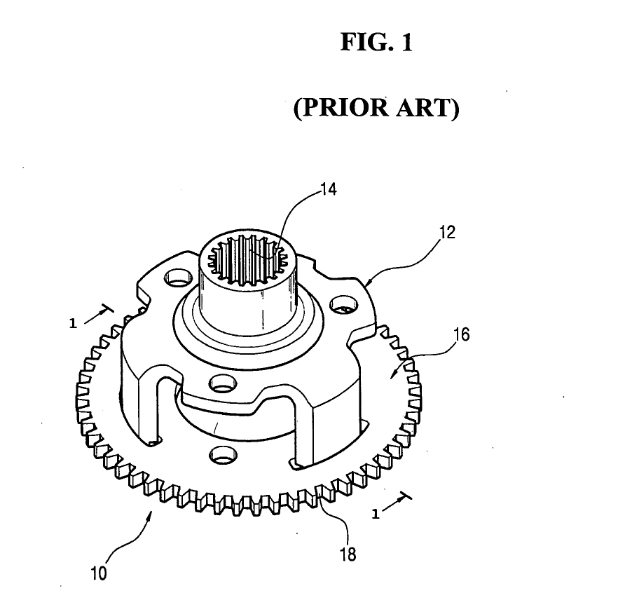

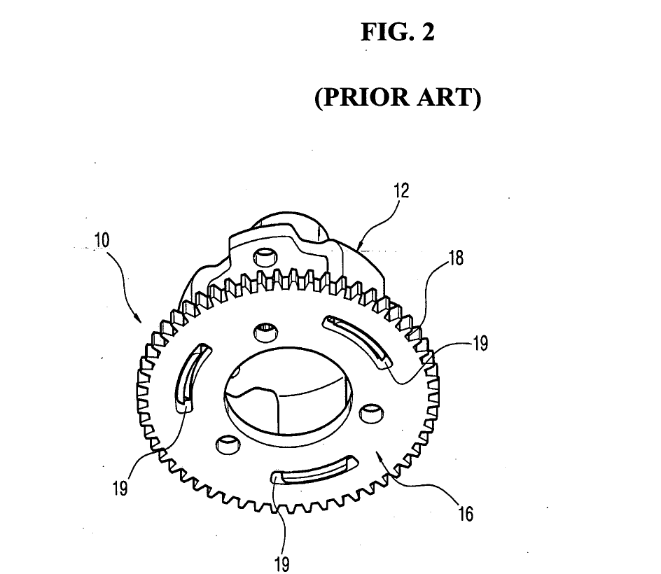

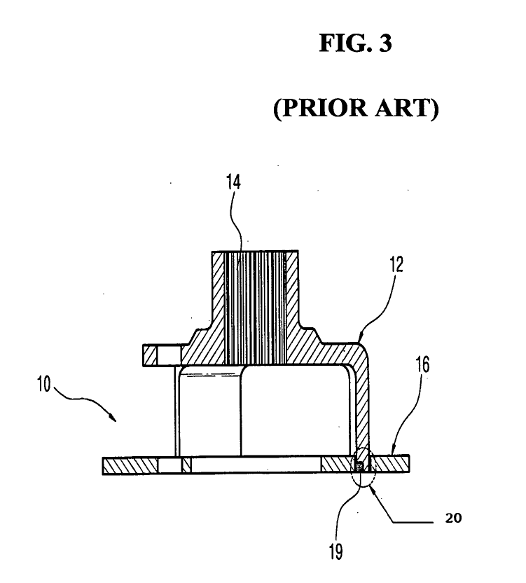

### DETAILED DESCRIPTION OF PREFERRED EMBODIMENTS

Hereinafter, such embodiments of the present invention are described in detail with reference to the accompanying drawings.

In a carrier of a planetary gear set of an automatic transmission includes a boss part 110 having a spline 112 in an inner surface of the center of the same, and a flange part 120 coupled with the boss part 110 and supporting a pinion. In the boss part 110, the portions except for the center portion in which the spline 112 is formed are formed in a circular plate shape. A plurality of bridges 124 are formed on an upper surface of the flange part 120 at regular intervals. The lower surface of the boss part 110 is blazing-coupled to the upper surface of the bridge 124 of the flange part 120, so that a pinion installation space is formed between the neighboring bridges 124.

In particular, the boss part 110 includes a plurality of blazing material insertion holes 114 in a portion coupled with the upper surface of the bridge 124.

In addition, at least more than two fixing protrusions 126 and fixing recesses 116 are provided on a coupling surface between the boss part 110 and the bridge 124 so that there is no movement between the boss part 110 and the flange part 120 during the blazing conjugation. Here, the fixing protrusion 126 and the fixing recesses 116 are coupled at the corresponding position between the conjugation surfaces.

The preferred embodiments of the present invention will be described in more detail with reference to the accompanying drawings.

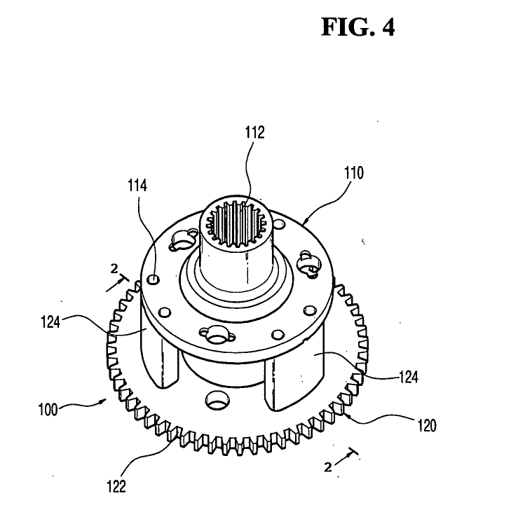

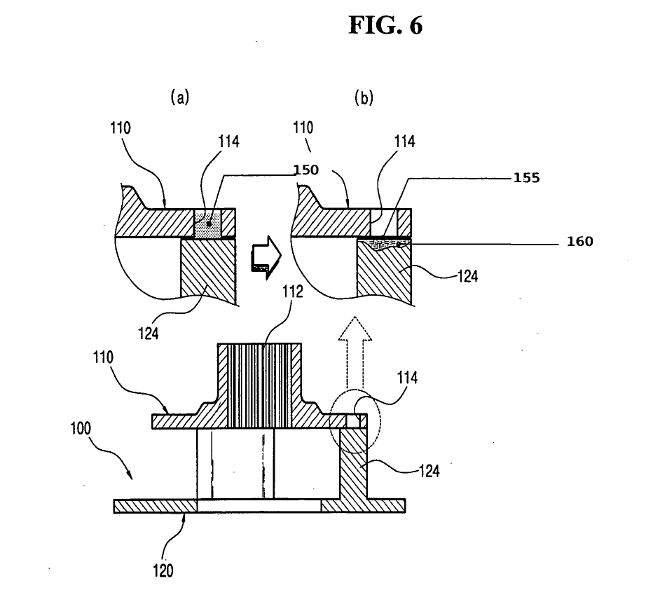

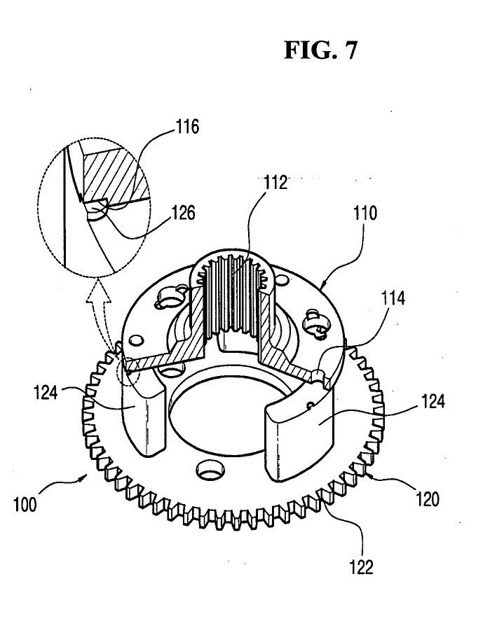

The present invention relates to a carrier of a planetary gear set of an automatic transmission. In the present invention, the boss part is formed in a circular plate shape unlike a conventional cup shape. A plurality of bridges are formed on an upper surface of the flange part at regular intervals. The lower surface of the boss part is blazing-coupled with an upper surface of the bridge of the flange part. FIG. 4 is a perspective view illustrating a carrier of a planetary gear set according to the present invention. In addition, FIG. 6 is a cross sectional view illustrating a blazing conjunction portion in a carrier of a planetary gear set according to the present invention, and FIG. 7 is an engaging cross sectional view illustrating a fixing recess and a fixing protrusion taken along the line 2-2 of FIG. 4.

The carrier 100 according to the present invention includes a boss part 110 having a spline 112 in an inner surface of the center, and a circular plate-shaped flange part 120 coupled with the boss part 110 and supporting the pinion.

In the boss part of the carrier 100 according to the present invention, the portions except for the center portion in which the spline 112 is formed are formed in a circular plate shape unlike a conventional cup shape. A plurality of bridges 124 are formed on the upper surface of the flange part 120 for thereby being engaged with the boss part 110 and forming a pinion installation space.

The lower surface of the boss part 110 and the upper surface of the bridge 124 of the flange part 120 are blazing-coupled for thereby implementing one carrier 100 in which the boss part 110 and the flange part 120 are integrally coupled. A pinion installation space is formed between the neighboring bridges 124.

In the carrier 100 according to the present invention, the bridges 124 are formed on the upper surface of the flange part 120 at regular intervals. Three bridges are needed to install three pinions.

In the present invention, the boss part 110 and the flange part 120 are integrally coupled by the blazing coupling method unlike a conventional electronic beam welding method. As shown in FIGS. 4 through 6, reference numeral 114 represents a blazing material insertion hole into which a blazing material 150 is filled before conjugation. A plurality of the blazing material insertion holes are formed on the upper surface of the bridge 124 in the boss part 110.

FIG. 6 is a cross sectional view illustrating a blazing coupling portion in the carrier according to the present invention and a state before/after the conjugation. The portion “a” of the left side illustrates a state that the blazing material is filled in the insertion hole 114 before the conjugation, and the portion “b” of the right side illustrates a state that the blazing material is heated and conjugated. A blazing conjugation layer 155 is formed between the lower surface of the boss part 110 and the upper surface of the bridge 124. A blazing spreading layer 160 is formed in a part of the upper portion of the bridge 124.

In the carrier 100 according to the present invention, there are provided a fixing recess 116 and a fixing protrusion 126 for supporting an accurate conjugation position between the boss part 110 and the flange part 120.

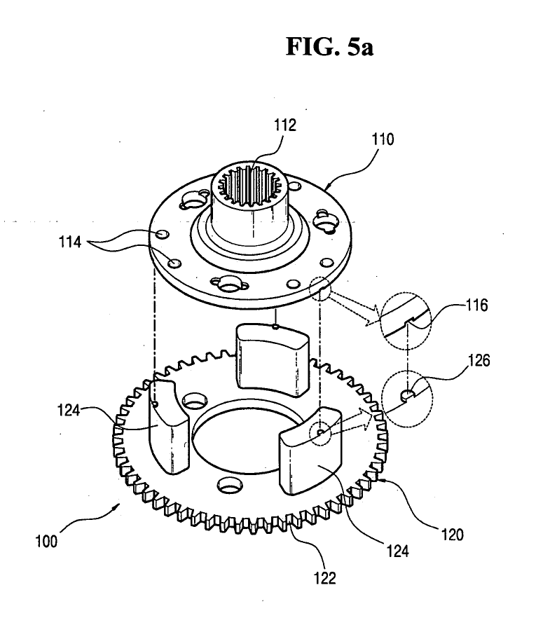

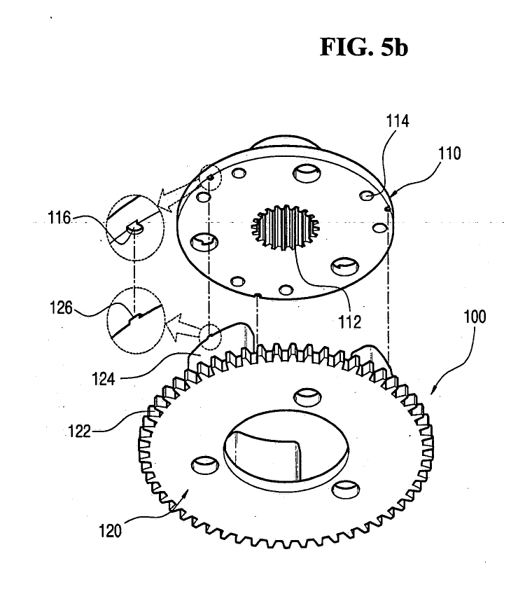

As shown in FIGS. 5A, 5B and 7, the fixing recess 116 and the fixing protrusion 126 are provided in the conjugation surfaces of the boss part 110 and the flange part 120, namely, between the lower surface of the boss part 110 and the upper surface of the bridge 124.

When the blazing conjugation is performed, the fixing recess 116 is accurately aligned with a corresponding fixing protrusion 126, and then the blazing material is inserted into the insertion hole, and the conjugation is performed. The boss part 110 and the flange part 120 are conjugated at the accurate position. In particular, there is no movement during the conjugation.

The number and shape of the fixing recess 116 and the fixing protrusion 126 are not limited to the number and shape disclosed herein. It is preferred that the coupling structure of the fixing recess 116 and the fixing protrusion 126 is provided in a previously determined portion of each bridge 124. The coupling structure of the same should be provided at least more than two portions.

In addition, the carrier 100 according to the present invention may be fabricated by the powder metallurgy method using a structural sintering alloy, not by the fine blanking, deep drawing or spline and helical gear processing methods.

Namely, the powder of material that may be powder-formed is filled into the mold, and a certain pressure is applied, so that the boss part 110 and the flange part 120 are separately pre-formed and are sintered at a certain temperature. The circular plate shaped boss part 110, the flange part 120 having the bridge 124, the fixing recess 116, and the fixing protrusion 126 may be formed before the sintering formation process. The spline 112 and the teeth 122 of the helical gear may be formed without an additional process.

As described above, in the carrier of the planetary gear set of an automatic transmission according to the present invention, the boss part is formed in a circular plate shape unlike the conventional cup shape. A plurality of bridges are formed on an upper surface of the flange part at regular intervals. The bridges are blazing-coupled with the boss part. It is possible to decrease a fabrication cost because an expensive process such as a deep drawing method for a conventional cup shape formation and an electronic beam welding method for coupling the boss part and the flange part in the case of the sintering formation and blazing conjugation methods is not used in the present invention.

In addition, it is possible to prevent a strain problem during a conventional electronic beam welding method by improving the construction of a welding portion.

Even though the present invention is described in detail with reference to the above embodiment, it is not intended to limit the scope of the present invention. It is evident from the foregoing that many variations and modifications may be made by a person having an ordinary skill in the present art without departing from the essential concept of the present invention.

What is claimed is:

1. A carrier of a planetary gear set of an automatic transmission, the carrier comprising a boss part having a spline at an inner surface thereof, and a flange part coupled with the boss part and supporting a pinion, wherein the boss part except for a center portion in which the spline is formed comprises a circular plate, and wherein a plurality of bridges are formed on an upper surface of the flange part at regular intervals, and a lower surface of the boss part is blazing-coupled with an upper surface of the plurality of bridges, and a pinion installation space is formed between adjacent bridges.

2. A carrier according to claim 1, wherein a plurality of blazing material insertion holes are formed at a coupling portion of the boss part, the coupling portion coupling with the upper surface of the of the plurality of bridges.

3. A carrier according to claim 1, wherein at least three fixing protrusions and fixing recesses are formed on a coupling surface of the boss part and the plurality of bridges for preventing movement between the boss part and the flange part during a blazing conjugation process, the at least three fixing protrusions being coupled to the at least three fixing recesses to prevent movement between the boss part and the flange part during a blazing conjugation process.
